(19) United States
(12) Patent Application Publication
(10) Pub. No.: US 2013/0104432 A1
(43) Pub. Date: May 2, 2013

(54) SIGN/BANNER DISPLAY SYSTEM

(71) Applicants: Chul PARK, Tempe, AZ (US); Young J. LEE, Tempe, AZ (US)

(72) Inventors: Chul PARK, Tempe, AZ (US); Young J. LEE, Tempe, AZ (US)

(21) Appl. No.: 13/524,570

(22) Filed: Jun. 15, 2012

Related U.S. Application Data
(60) Provisional application No. 61/553,464, filed on Oct. 31, 2011.

(51) Int. Cl. G09F 15/00

(52) U.S. Cl. 40/607.01

(57) ABSTRACT

A sign/banner display system having one or more central support structures and a plurality of flexible rods connected to the one or more central support structures to provide a versatile uniquely configurable sign/banner display. The flexible rods can be telescoping in nature and have an engaging means for engaging and securing the sign/banner thereto. The central support structures can be differently configured for hanging or standing applications and can be mixed and matched to create the desired sign/banner.

### CROSS-REFERENCE TO RELATED APPLICATIONS

This application claims priority from U.S. Provisional Patent Application Ser. No. 61/553,464 filed on Oct. 31, 2011.

### BACKGROUND

1. Technical Field

The present principles relate to sign/banner displays. More particularly, they relate to a sign/banner system that is infinitely configurable to provide both two dimensional (2D) and three dimensional (3D) signs/banners.

2. Description of related art

Sign and banner displays are commonly known and used throughout the business world in the advertising and promotions for the sale of goods, trade shows, charitable events, etc. One primary drawback to such known sign/banner systems that they often require being custom made for a particular application and therefore require more time and money than is often warranted for the particular application.

Other known sign/display systems do not have the ability to be used in both a 2-dimensional or 3-dimensional application.

### SUMMARY

In accordance with one implementation of the invention, the sign/banner display system includes at least one central support structure having a plurality of holes therein, at least one flexible support rod having one end configured for insertion into one of the plurality of holes in the central support structure and the other end configured to engage a sign/banner and sign/banner engaging means configured to be secured on the end of the at least one flexible support rod. The central support structure being configured for connecting at least one of a hanging support or a rigid support;

In accordance with another implementation, the sign/banner display system includes at least one first central support structure having a plurality of holes therein, at least one second central support structure having a plurality of holes therein and having a bore passing entirely there through, a plurality of flexible support rods having one end configured for insertion into one of the plurality of holes in the at least one first and at least one second central support structures and the other end being configured to engage a sign/banner, and sign/banner engaging means configured to be secured to the end of the at least one support rod. The first central support structure being configured for connecting at least one of a hanging support or rigid support; and at least one first central support and at least one second central support being attached to each other using a rigid support.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1A is plan view of a support sphere for the sign/banner system according to an implementation of the invention;

FIG. 1B is a plan view of a cylindrical shaped support for the sign/banner system according to an implementation of the invention;

FIG. 2A is a side view of a plurality of flexible sign/banner support rods according to an implementation of the invention;

FIG. 2B is a side view of a plurality of hook ends use in conjunction with the flexible sign/banner rods according to an implementation of the invention;

FIG. 2C is an example of a rigid support rod according to an implementation of the invention;

FIGS. 3A-3H show various examples of sign/banner system according to an implementation of the present invention;

FIG. 4A shows a side view of an extendable flexible rod according to another implementation of the invention;

FIG. 4B is an example of a pressure fit collar used with the flexible rod of FIG. 4A;

FIG. 4C is another example of an extendable flexible rod according to another implementation of the invention;

FIG. 4D is another example of an extendible rod according to another implementation of the invention;

FIG. 4E is another example of the extendible rod according to another implementation of the invention;

FIG. 5 is another example of a support sphere having lighting means;

FIG. 6A shows another support sphere according to another implementation of the invention;

FIGS. 6B-6D show various implementations of the sign/banner display system using the support sphere of FIG. 6A, according to an implementation of the invention;

FIG. 7A shows another support sphere according to a further implementation of the invention;

FIGS. 7B-7E show various implementation of the sign/banner display system using the support sphere of FIG. 7A, according to a further implementation of the invention;

FIG. 8A shows another support sphere according to yet a further implementation of the invention;

FIGS. 8B and 8C shown various implementations of the sign/banner display system using the support sphere of FIG. 8A; and

FIGS. 9A and 9B show various implementations of the sign/banner display system using varying combinations of the support structures (spheres) shown in FIGS. 6A, 7A and 8A, according to other embodiments of the invention.

### DETAILED DESCRIPTION

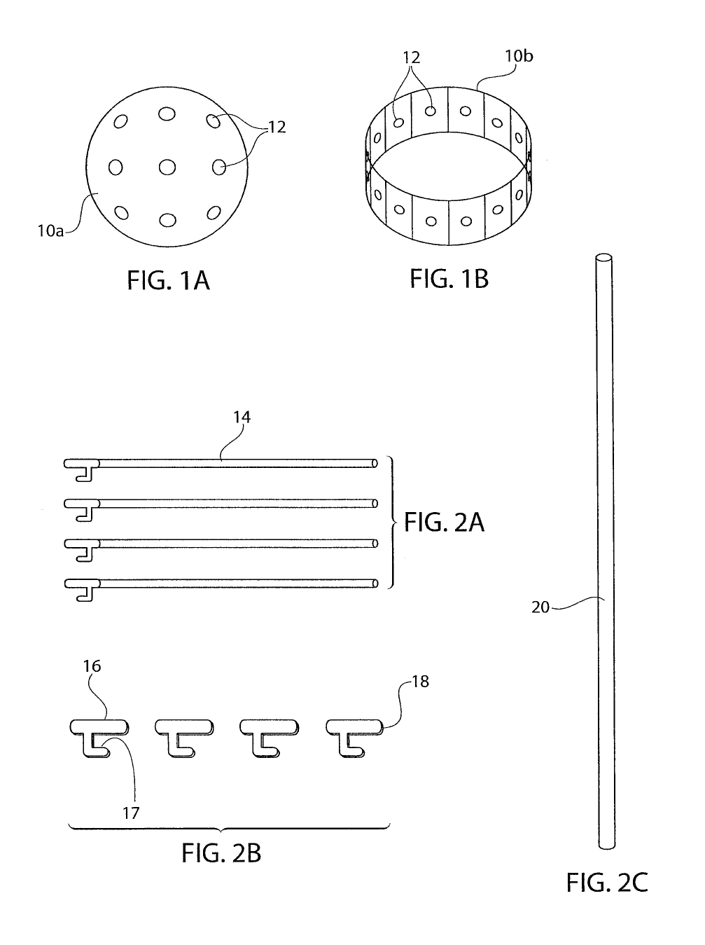

In accordance with one embodiment shown in FIGS. 1A-3H, the sign or banner display includes a central support structure. The central support structure can be spherical in shape, for example sphere 10A shown in FIG. 1A. Alternatively, the central support structure can be cylindrical in shape, see cylinder 10B shown in

FIG. 1B. As shown, the preferred central support structure is a sphere 10A having many holes 2 therein for receiving two or more support rods 14. In other embodiments, the central support structure can be in any desired form, for example, a triangle, cylinder 10B, square, etc., in order to provide the support for the attached sign/banner.

As shown in FIGS. 2A-2C, a primary support 20 is provided which can be made of steel, rubber, plastic, wood, aluminum, or other suitable material and is configured to releasably connect to the central support structure 10 (via one of the holes therein) and being configured support or hold the central support structure 10 and connect the same to a stand, wall or ceiling mount for display of the respective sign/banner.

The support rods 14 are bendable, yet formed of a rigid or hard plastic, steel or aluminum. The support rods are provided for selective inserting into the holes 12 of the central support structure 10. The bendable rods 14 are preferably made of a hard plastic so as to retain their straight shape. However, any other suitable material may be used without departing from the scope of this disclosure.

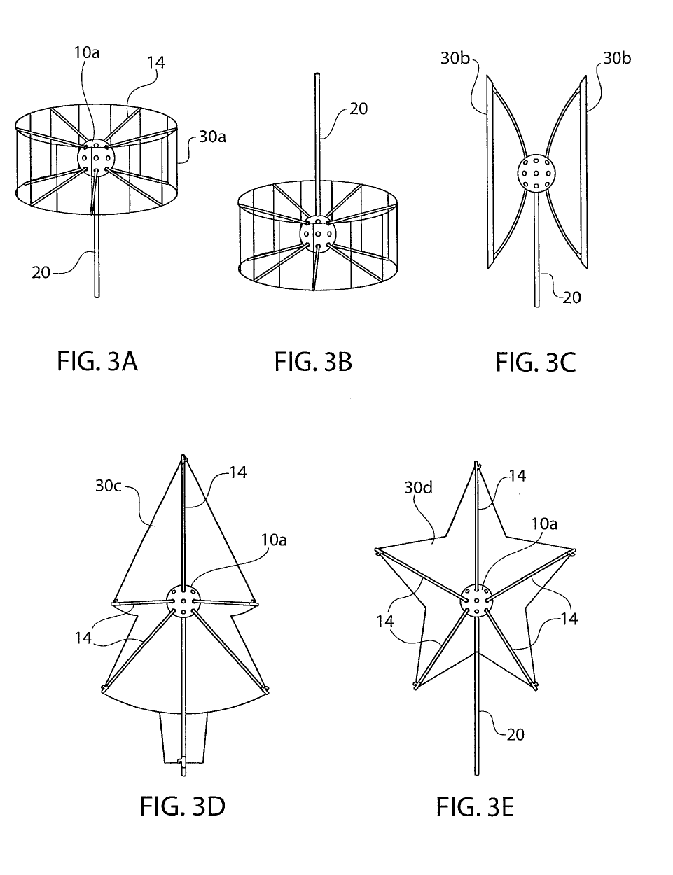

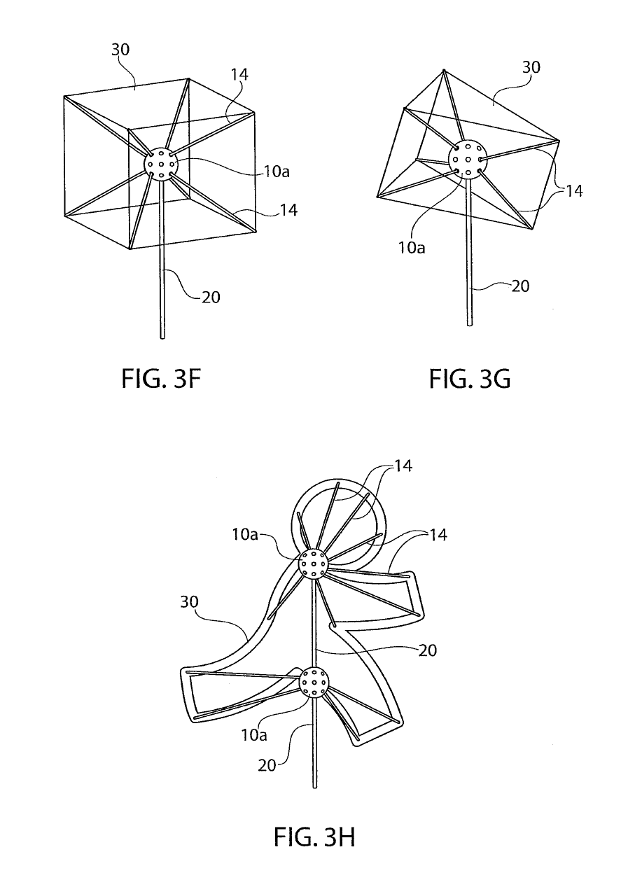

Hook ends 16 having a rod engaging end 18 and hook portion 17 are provided to attach to the distal end of each support rod (after inserted into the central support structure). The hook ends 16 (as shown) enable the attachment of an almost limitless number of shapes and size signs/banners 30. As will be appreciated from the FIGS. 3A-3H (e.g., side views), when opposing supports rods 14 are flexed to connect their hooksl6 to a sign/banner 30, they will automatically pull the sign/banner 30 taught as a result of the support rod's desire to remain straight (i.e., biased toward a straight position).

In this manner, the central support structure 10 (with a plurality of holes 12 therein), along with any number of support rods 14 and with corresponding hooks 16, can be used to create an almost limitless number of configurations (e.g., shapes and sizes) in signs/banners, as shown in the examples of the FIGS. 3A-3H.

As shown in FIGS. 3A-3H, the sign/banner 30 can be almost any shape imaginable. For example, a cylinder or spinning type sign 30a (FIGS. 3A, 3B), flat 30b and positioned on different sides of the central support structure 10 (FIG. 3C), or unique shapes line a Christmas tree (FIG. 3D) or a star (FIG. 3E). FIGS. 3F-3H show various 3-dimensional signs 30 where the shapes are limitless. FIG. 3H shows an example of the use of two central support structures 10a connected together with one rigid support 20 and being supported by another rigid support 20. Here it will become obvious that the shape and configurations for the sign/banners are only limited by the user's imagination and can be implemented using the sign/banner display system according to embodiments of the present invention.

Those of skill in the art will appreciate that the angles of the holes 12 in the central support structures 10, and the lengths of the support rods 14 releasably connected thereto help to create the almost limitless number of configurations of shapes and sizes for the sign/banner display of the present invention.

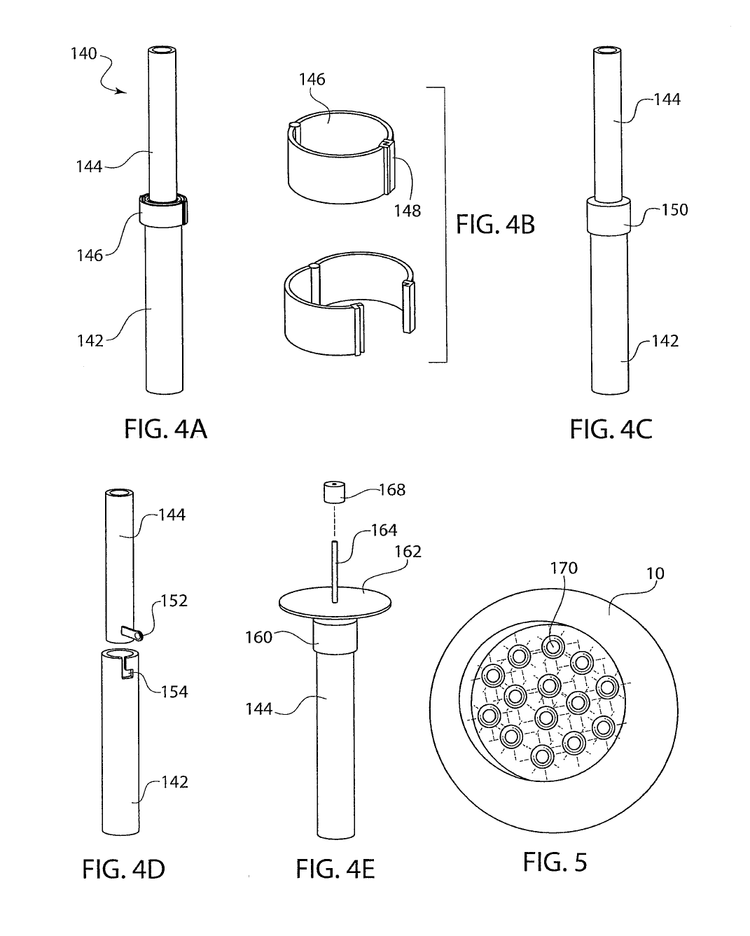

FIGS. 4A-4E show alternative implementations of the bendable rods 140, according to other embodiments of the invention. FIG. 4A shows a rod 140 that is telescoping in nature and has a larger rod 142 that receives a smaller rod 144 such that any desired length of the rod can be achieved. Once the desired length has been achieved, a snap compression 146 (FIG. 4B) around the junction between the larger rod 142 and the smaller rod 144 so as to secure the two with respect to each other. The snap compression fitting 146 includes a snap 148 or other releasable connection that allows the same to function as described above.

FIG. 4C shows another embodiment of the rod 140 where a screw like compression fitting 150 is used to secure the larger rod 142 with the smaller rod 144 when at the desired length.

FIG. 4D shows another embodiment of the rod 140 where a post 152 at the base of the smaller rod 144 is received in a slot 154 in the larger rod, such that the slot received and secures the post in a locked position.

In the embodiments shown in FIGS. 4A0-4D, the hook ends 16 can be added to one end of the rod 140 while the other would be configured for insertion into the central support structure 10.

FIG. 4E shows a different rod assembly according to another embodiment of the invention. Here, the top of the smaller rod 144 (internal to rod 144), is configured to include a surface 162 having a rod or pin 164 centrally extended outward therefrom. In operation, the pin 164 engages the holes in the signs/banners 30 and the cap 168 can be used to secure the respective rod 140 to the sign/banner such that the same will sandwiched between the surface 162 and the cap 168. This embodiment eliminates the need for hook ends 16 described above by incorporating the same directly into the extendable support rod 140.

FIG. 5 shows an alternative embodiment of central support structure 10 where a plurality of LED lights 170 are integrated therein. In this configuration, lighting can be added to the sign/banner system of the present invention. The lights 170 can be configured in any desired form and can use one or more colors. With the use of lights added to the central structure, a plurality of lighting effects could be added to the sign/display, such as, for example, blinking lights, streaming lights, dynamically changing colors, etc.

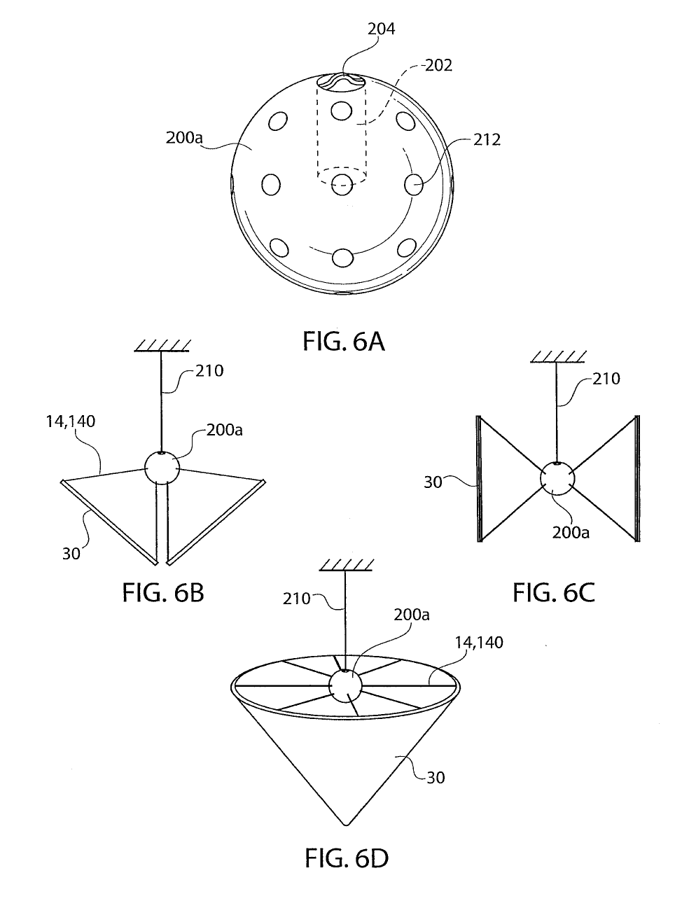

FIG. 6A shows another embodiment of a central support structure 200A according to one phase of the sign/banner display system of the present invention. The central support structure 200 includes a plurality of holes 12 for receiving the support rods 14, 140 and also includes a hook like structure 204 configured over an aperture 202 in the central support. As shown in FIGS. 6B-6D, this central support structure 200 is particularly configured for hanging applications. A string, or rigid support 210 connects to the hook 204 can be connected to a ceiling or other structure that is above the desired display region. As shown, the sign/banner 30 can take many different forms and through the use of the bendable rods 14,140 any type of sign/banner design can be achieved.

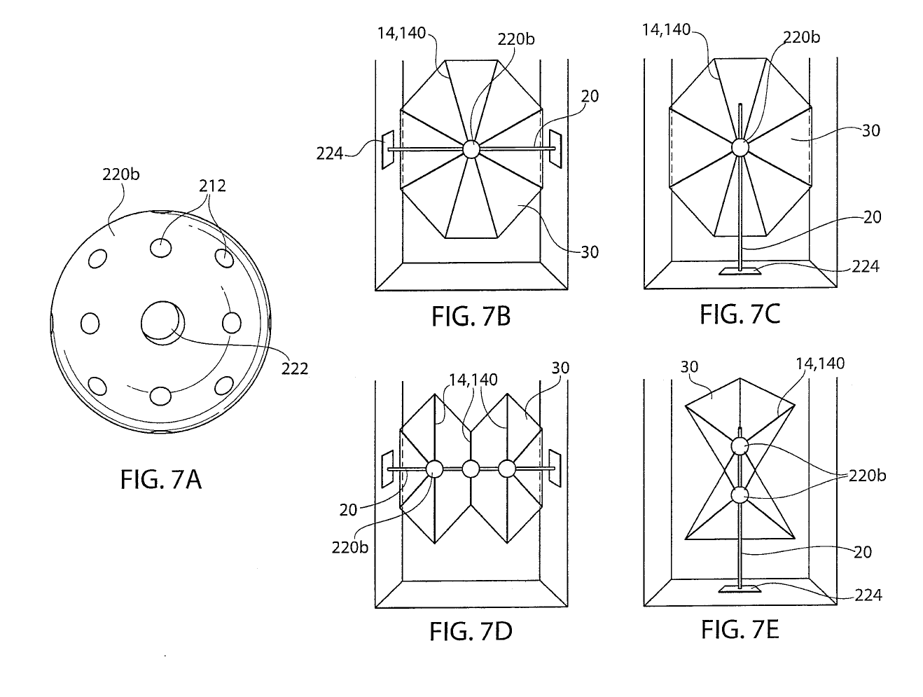

FIG. 7A shows another embodiment of a central support structure 200B according to a second phase of the sign/banner display system of the present invention. The central support structure 200B includes a plurality of holes 212 for receiving the support rods, and an aperture 222 that passes entirely through the support. As shown in FIGS. 7B-7E, one or more central support structures 200B can be used in conjunction with a rigid support 20 to provide various configurations and implementations of the sign/banners 30. With the use of the central support structure 200B, the sign/banner 30 can be supported from walls (FIGS. 7B and 7D) or from a floor (FIGS. 7C and 7E).

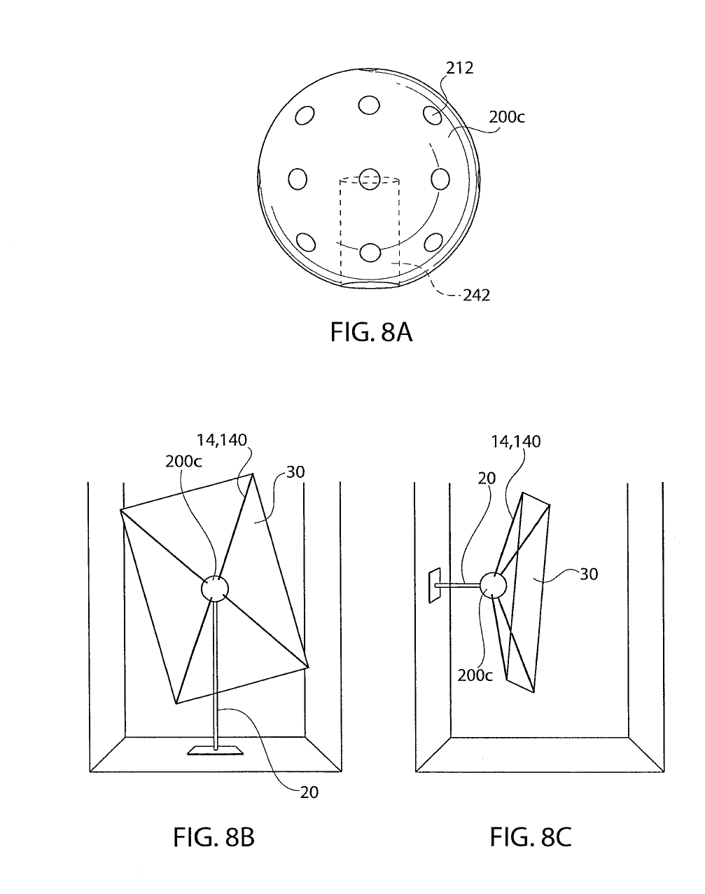

FIG. 8A shows another central support structure 200C according to a third phase of the sign/banner display system of the present invention. The central support structure 200C includes a plurality of holes 212 for receiving the support rods, and a partial hole 242 configured to receive the rigid support 20. In this manner, the support 200C with rigid support 20 can be supported on a floor (FIG. 8B) or a wall (FIG. 8C) such that the sign/banner 30 connected to the support by rods 14, 140 can be displayed in the desired position.

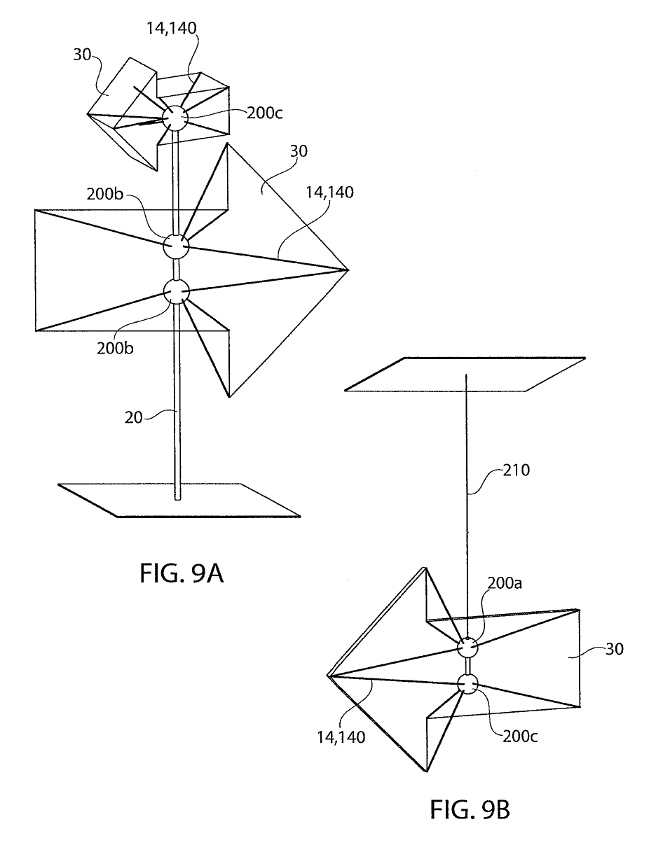

FIGS. 9A and 9B show how the various phases of the central support structures 200A, 200B and 200C can be combined to provide an almost infinite number of configurations for the sign/banner display system of the invention.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

What is claimed is:

1. A sign/banner display system comprising:
at least one central support structure having a plurality of holes therein, said central support structure being configured for connecting at least one of a hanging support or a rigid support;
at least one flexible support rod having one end configured for insertion into one of the plurality of holes in the central support structure and the other end configured to engage a sign/banner; and
sign/banner engaging means configured to be secured on the end of the at least one flexible support rod.

2. The sign/banner display system of claim 1, wherein said central support structure having said hanging support comprises a partial bore in the central support structure and a hook positioned over the bore.

3. The sign/banner display system of claim 1, wherein said central support structure having a rigid support comprises a partial bore in the central support structure, said bore being configured to receive one end of the rigid support.

4. The sign/banner display system of claim 1, wherein said engaging means comprises a removable hook end having an aperture configured to be releasably received by one end of the flexible support rod, the removable hook having a portion configured to be inserted into a hole in the sign/banner.

5. The sign/banner display system of claim 1, wherein said at least one flexible support rod comprises a telescoping rod assembly having means for securing the same at a desired length, said telescoping rod assembly comprising an upper telescoping rod slidably engaged with a lower receiving rod.

6. The sign/banner display system of claim 5, wherein the securing means comprises a snap compression fitting configured to secure the telescoping rod assembly at the desired length.

7. The sign/banner display system of claim 5, wherein the securing means comprises a threaded compression fitting configured to secure the telescoping rod assembly at the desired length.

8. The sign/banner display system of claim 5, wherein the securing means comprises a pin on a lower portion of the telescoping rod and a securing slot on an upper portion of the lower receiving rod.

9. The sign/banner display system of claim 1, wherein said at least one flexible support rod comprises:
a telescoping rod assembly having means for securing the same at a desired length, said telescoping rod assembly comprising an upper telescoping rod slidably engaged with a lower receiving rod, said lower receiving rod configured to be inserted in one of the plurality of holes in the central support structure; and
wherein the engaging means comprises a connection system for attaching the sign/banner to an upper end of the upper telescoping rod, said connection system comprising:
a flat surface extending outward from the upper end transverse to a central axis of the upper telescoping rod;
a pin extending upward along the central axis of the upper telescoping rod and configured to engage an associated hole in the sign/banner; and
a cap configured to be securely fitted to the pin after the pin has been passed through the associated hole in the sign/banner.

10. The sign/banner display system of claim 1, wherein said central support structure comprises lighting means for selectively illuminating the connected sign/banner.

11. A sign/banner display system comprising:
at least one first central support structure having a plurality of holes therein, said central support structure being configured for connecting at least one of a hanging support or rigid support;
at least one second central support structure having a plurality of holes therein and having a bore passing entirely there through, said at least one first central support and said at least one second central support being attached to each other using a rigid support;
a plurality of flexible support rods having one end configured for insertion into one of the plurality of holes in the at least one first and at least one second central support structures and the other end being configured to engage a sign/banner; and
sign/banner engaging means configured to be secured to the end of the at least one support rod.

12. The sign/banner display system of claim 11, wherein said at least one flexible support rod comprises a telescoping rod assembly having means for securing the same at a desired length, said telescoping rod assembly comprising an upper telescoping rod slidably engaged with a lower receiving rod.

13. The sign/banner display system of claim 12, wherein the securing means comprises a snap compression fitting configured to secure the telescoping rod assembly at the desired length.

14. The sign/banner display system of claim 12, wherein the securing means comprises a threaded compression fitting configured to secure the telescoping rod assembly at the desired length.

15. The sign/banner display system of claim 12, wherein the securing means comprises a pin on a lower portion of the telescoping rod and a securing slot on an upper portion of the lower receiving rod.

16. The sign/banner display system of claim 11, wherein at one or more of the at least one first central support structure and at least one second central support structure further comprise lighting means for selectively illuminating the connected sign/banner.
